(19) United States
(12) Patent Application Publication
(10) Pub. No.: US 2014/0108154 A1
(43) Pub. Date: Apr. 17, 2014

(54) DISPLAY OF CROSS-SELL ADVERTISEMENTS TO A USER BASED ON GENETICS

(71) Applicant: FABRIC MEDIA, INC., San Diego, CA (US)

(72) Inventors: Alexander M. Aravanis, San Diego, CA (US); Nicholas M. Hofmeister, San Diego, CA (US); Jason L. Pyle, San Diego, CA (US)

(73) Assignee: Fabric Media, Inc., San Diego, CA (US)

(21) Appl. No.: 13/653,414

(22) Filed: Oct. 17, 2012

(51) Int. Cl. G06Q 30/02

(52) U.S. Cl. 705/14.66

(57) ABSTRACT

Display of cross-sell advertisements to a user, including, but not limited to, in a social genetics network includes: associating genetic data with product and service categories; accessing specific genetic data of a user to obtain a set of product and service categories associated with the genetic data of the user; analyzing non-genetic data of the user, including past purchase history, and analyzing the genetic data of the user to discover correlations in preferences of the user; selecting one or more desired product and service categories from the set of the product and service categories that match the correlations in the preferences of the user; sending a product or service request to at least one advertiser for a cross-sell advertisement relating to the desired product and service categories; and responsive to receiving the cross-sell advertisement from the advertiser, displaying the cross-sell advertisement on an electronic device of the user.

### BACKGROUND

Membership of social networking sites continue to rise. A social networking site is an online website, platform, or service that enables the creation of social relations or networks among users who may share similar backgrounds, connections, interests or activities. Most social networking sites provide free to a user, a user profile, user social links, and an ability to post comments, or share messages with other users. Once the user has created a profile and create social links with other users, the social networking sites allow the users to share ideas, activities, events and interest within their individual networks. Example types of social networking sites include dating sites, friendship sites, business sites and hybrids.

In addition, companies offering genealogical related services have begun to offering limited social networking services to their users. Examples include Ancestry.com and 23andMe. Ancestry.com is a subscription-based genealogy research website with billions of online records. Ancestry.com offers an ancestry DNA test in which a user provides a DNA sample and DNA autosomal testing technology is used as a way for the user to find family across lines in the user's family tree. For example, Ancestry.com uses the DNA data of its members to determine global ancestry, maternal line ancestry, paternal line ancestry and familial relatedness.

23andMe is a personal genomics and biotechnology company that provides genetic testing for its users. Customers provide a sample which is analyzed on a DNA microarray to find specific single-nucleotide polymorphisms (SNPs) with a goal of providing whole genome sequencing. The results are posted online for assessment of a user's genealogy, including global origins, ancestral lineages, and finding relatives. 23andme's Relative Finder lets a user find other 23andme members who match the user's DNA and then make anonymous contact with those members. 23andme also uses the DNA data for health purposes, including finding inherited traits, carrier status, disease risk and drug response.

Although members of genealogical related websites may find the services appealing, these services are primarily ancestry and health based, rather than social, entertainment or business based. This forces members of conventional genealogical related websites to continue to use mainstream social networking sites for creating social networks with other users who share similar backgrounds, connections, interests or activities.

Accordingly, it would be desirable to provide methods and systems for displaying cross-sell advertisements to a user.

### BRIEF SUMMARY

Exemplary embodiments provide methods and systems for displaying cross-sell advertisements to a user, including but not limited to, in a social genetics network. Aspects of the exemplary embodiments include: associating human genetic data with product and service categories; accessing specific genetic data of a user from a database to obtain a set of product and service categories associated with the genetic data of the user; analyzing non-genetic data of the user, including past purchase history, and analyzing the genetic data of the user to discover correlations in product and service preferences of the user; selecting one or more desired product and service categories from the set of the product and service categories that match the correlations in the product and service preferences of the user; sending a product or service request to at least one advertiser for at least one cross-sell advertisement relating to the desired product and service categories; and responsive to receiving at least one cross-sell advertisement from the advertiser, displaying the at least one cross-sell advertisement on an electronic device of the user.

### BRIEF DESCRIPTION OF SEVERAL VIEWS OF THE DRAWINGS

FIG. 1 is a diagram illustrating one embodiment of a social genetics network system that provides personal and business services.

FIG. 2 is a flow diagram illustrating one embodiment of a process for creating a social genetics network.

FIG. 3 is a block diagram illustrating example user interface (UI) pages that may be generated and presented to the user on electronic device once connected to the social genetics network website.

FIGS. 4A and 4B are diagrams illustrating example embodiments for the social genetics profile page.

FIGS. 5A and 5B are diagrams illustrating example embodiments for the compare users page.

FIGS. 6A and 6B are diagrams illustrating example embodiments of the thread details page.

FIG. 7 is a diagram illustrating an example embodiment of the view connections page.

FIG. 8 is a diagram illustrating an example embodiment of the view other profile page.

FIG. 9 is a table illustrating examples phenotype SNPs traits.

FIG. 10 is flow diagram illustrating one embodiment for the process of displaying cross-sell advertisements related to genetic data of a user.

### DETAILED DESCRIPTION

The exemplary embodiments relate to displaying cross-sell advertisements to a user, including but not limited to, in a social genetics network. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

### DEFINITIONS

“Active user” or “the user” in some embodiments is a user in a genetic social network database that is logged into and interacting with the genetic social network.

“Compared user” is a user that is shown on a comparison page when the user clicks on a another user.

“Cross sells” is an advertisement shown on pages of the genetic social network that are related to a particular thread.

“Relatedness score” is an estimation representing a degree of relation provided by the genetic social network between a pair of users, e.g., 1 may indicate immediate blood relative, 2 may indicate cousin, and so on.

“Shared thread count” is a number of shared threads between the active user and a compared user.

“Similarity score” is a number provided by the genetic social network showing the similarity between two users. Scores may range from 1 to 100, where 100 is extremely similar.

“Similar users” are users in the genetic social network database who share some amount of similarity with the active user, based on their similarity score.

“Social genetics network” is an online website that creates social relations or networks among users based on genetic and non-genetic data sets describing those users and an analysis of the genetic and non-genetic data sets from which information about a user can be inferred and from which information about the relationships between the user and other users in the network can be inferred.

“Trait” or “Thread” is a distinct variant of a phenotypic character of an organism, e.g., a human, that may be inherited, environmentally determined, or a combination thereof, and may be genetic or non-genetic. Traits/threads can be shared among individuals and are assigned to users by the genetic social network. Examples of traits may include hair color, optimism, desire for coffee, pain tolerance, activeness of lifestyle, and ancestry.

“Thread count” is a number of users in the genetic social network database that share a particular thread.

Genetic Social Network

Social media has experienced a meteoric rise in the past two decades. At the same time, the cost of genetic sequencing has an equal exponential drop in cost. Both social media and genetics have room for growth, particularly where they may intersect.

The exemplary embodiments described herein provide a social genetics network comprising users, genetic and non-genetic data sets describing those users, analysis of genetic and non-genetic data sets from which information about a user can be inferred, and analysis of those data sets from which information about the relationships between the user and other users in the network can be inferred. According to one aspect of the exemplary embodiment, the genetic and non-genetic data sets are used to infer human trait similarities between users. The social genetics network provides personal for exploring the similarities of a user's traits with other users and groups of users, including friends, family, neighbors, colleagues and people around the world. The social genetics network provides business services that include the display of cross-sell advertisements to a user based on the genetic and non-genetic data sets.

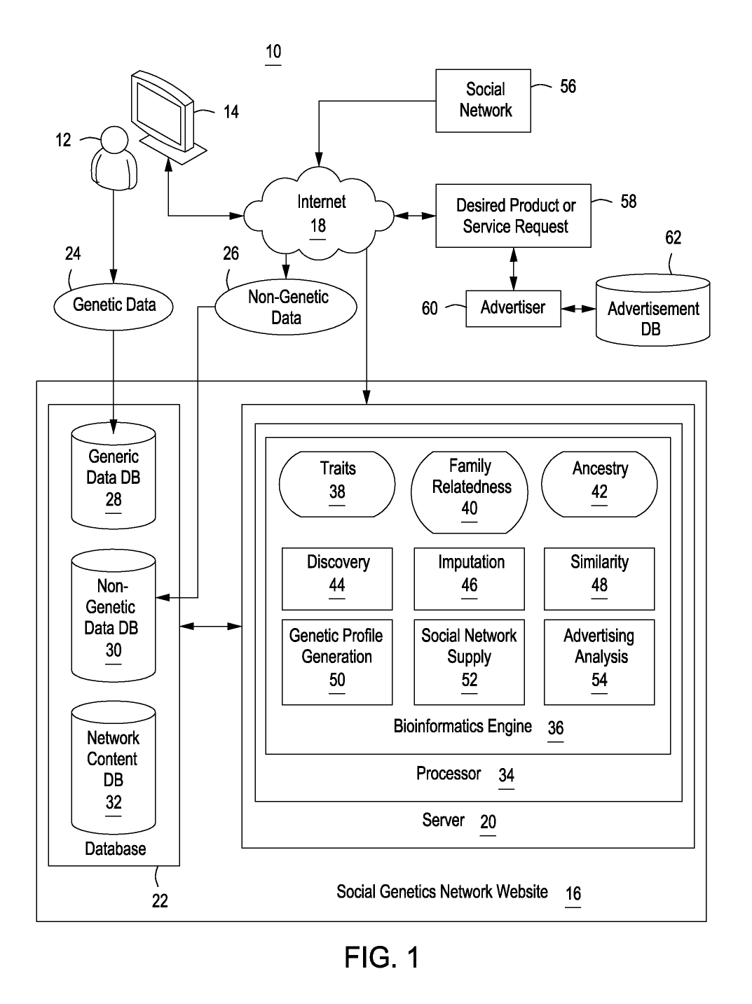

FIG. 1 is a diagram illustrating one embodiment of a social genetics network system that provides personal and business services. Personal services provided by the social genetics network 10 may include entertainment, connection with friends, discovery of new people of interest, discovery of new things/events of interest. Business services provided by the social genetics network 10 may include selling of products, advertising network, and providing a deeper understanding of the users.

The social genetics network 10 includes one or more users, such as user 12, and their electronic devices, such as electronic device 14, which are connected to a social genetics network website 16 over the Internet 18. The social genetics network website 16 may comprise one or more servers 20 and/or computers that dynamically generate webpages from one or more databases, such as database 22, to provide social genetics networking services to the users based on genetic data 24 and non-genetic data 26 of the users. The social genetics network website 16 may also comprise an application (not shown) executing the electronic device that accesses the one or more servers 20 that interact with the user and displays content from the social genetics network website 16.

In one embodiment, the social genetics network website 16 may include a genetic data database 28, a non-genetic data database 30, and a network content database 32. In one embodiment, one or more of the genetic data database 28, the non-genetic data database 30 and the network content database 32 may comprise database 22. In an alternative embodiment, one or more of the genetic data database 28, the non-genetic data database 30 and the network content database 32 may be implemented as tables, rather than databases. The network database 32 may contain network maps of the users' pre-existing social networks (e.g., Facebook, Twitter, Pinterest) and the new network connections created by the bioinformatics engine 36, including new friendships, messages between users, shared relatedness and similarity scores.

In one embodiment, the social genetics network website 16 may further include a processor 34 that executes software for analyzing the genetic data 24 and the non-genetic data 26 for each of the users to generate bioinformatics data. In one embodiment, the software may comprise a bioinformatics engine 36 that determines bioinformatics data for each of the users in the form of at least one trait 38, any family relatedness 40, and ancestry 42. According to one embodiment, the bioinformatics engine 36 may determine the traits 38 of a particular user 12 based in part on known phenotypic and/or phenotypic relationships (e.g., eye color, bitter tasting, risk aversion, and so on) found in the genetic data 24.

The bioinformatics engine 36 may determine family relatedness 40 and ancestry 42 by conventional techniques. For example, the bioinformatics engine 36 may determine family relatedness 40 by determining a degree of familiar relatedness to other users (e.g. 2^{nd} cousin), and by determining which sections of the user's chromosome/traits/genes/SNP's were inherited from a relative. The bioinformatics engine 36 may determine ancestry 42 by determining ancestral origins using maternal, paternal and autosomal genetic information (e.g., race and geographic location).

According to one aspect of the exemplary embodiment, the bioinformatics engine 36 may further include a discovery component 44, an imputation component 46, a similarity component 48, a genetic profile generation component 50, a social network support component 52 and an advertising analysis component 54, as described further below.

Both the server 20 and the electronic device 14 may include hardware components of typical computing devices, including a processor, input devices (e.g., keyboard, pointing device, microphone for voice commands, buttons, touchscreen, etc.), and output devices (e.g., a display device, speakers, and the like). The server 20 and electronic device 14 may include computer-readable media, e.g., memory and storage devices (e.g., flash memory, hard drive, optical disk drive, magnetic disk drive, and the like) containing computer instructions that implement the functionality disclosed when executed by the processor. The server 20 and the electronic devices 14 may further include wired or wireless network communication interfaces for communication.

Although the server 20 is shown as a single computer, it should be understood that the functions of server 20 may be distributed over more than one server/computer, and the functionality of software components may be implemented using a different number of software components. For example, the bioinformatics engine 36 may be implemented with a different number of components/modules from that shown in FIG. 1 or the bioinformatics engine 36 may itself be implemented as separate applications.

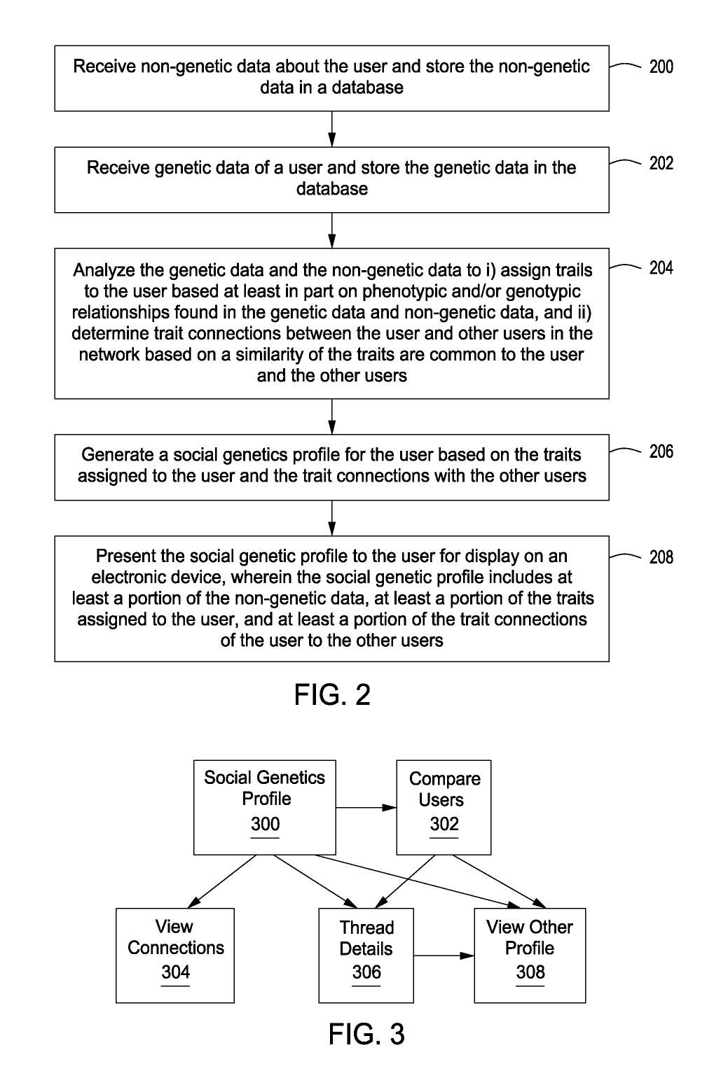

FIG. 2 is a flow diagram illustrating one embodiment of a process for creating a social genetics network. As a condition of a user registering with the social genetics network website 16, the user 12 may be requested to provide genetic data 24 and non-genetic data 26.

Thus, in one embodiment, the process may begin the server 20 receiving non-genetic data 26 about the user and storing the non-genetic data 26 in the database 22 (block 200).

In one embodiment, as part of the registration process, a user interface of the social genetics network website 16 may prompt the user 12 to input non-genetic information about his or her self using the user's electronic device 14. Example of the non-genetic data 26 may include, but is not limited to, contact information, comments, likes/dislikes, social networking behavior, images, videos, photos, identification of friends, family and colleagues.

According to another aspect of the exemplary embodiment, the genetic social network 10 may attempt to automatically collect non-genetic data 26 about the user from an existing social network 56 instead of, or in addition to, obtaining information from the user. Examples of currently existing social networks may include Facebook, Google+, LinkedIn, Myspace, Twitter and Pinterest. In this context, the non-genetic data 26 may include other forms of digital data besides existing social network data and data input by the user, such as the user's recent search terms, mobile phone application data, location information, and the like. In one embodiment, the social network support component 52 may be responsible for automatically collecting the non-genetic data 26 and storing the non-genetic data 26 in the network content database 32. Collecting the non-genetic data 26 about the user from an existing social network(s) 56 may require obtaining the user's log-in credentials to the social network(s) 56.

Once the server 20 receives the non-genetic data 26 either by entry of the user 12 or from the existing social network(s) 56, the bioinformatics engine 36 may create a non-genetic profile for the user and store the non-genetic profile in the non-genetic data database 30.

The registration process may further include the social genetics network website 16 receiving the genetic data 24 and storing the genetic data in the database 22 (block 202).

In one embodiment, the social genetics network website 16 may collect the genetic data 24 from the user 12 as follows. First, a biological sample is obtained from the user, where the biological sample may include, but is not limited to, saliva, tissue, blood, hair, or other biomass. Many commercially available DNA sample collection kits exist that may be provided (e.g., by post) to the user for obtaining the biological sample from user. The user may return the kit containing the biological sample to either a third-party service or to a service provided by the social genetics network website 16 for processing. Processing the biological sample may include, for example, extracting, purifying and/or quantifying the sample to obtain genetic material, such as DNA or RNA, and then sequencing or genotyping the genetic material to produce the genetic data 24 in the form of digital genetic sequence data or genotype data.

Techniques for sample collection and processing may be found, e.g., Tietz, Textbood of Clinical Chemistry and Molecular Diagnostics, 4th Ed., Chapter 2, Burtis, C. Ashwood E. and Bruns, D, eds. (2006); Sampling and Sample Preparation for Field and Laboratory, (2002); Venkatesh lyengar, G., et al., Element Analysis of Biological Samples: Priniciples and Practices (1998); Wells, D., High Throughput Bioanalytical Sample Preparation (Progress in Pharmaceutical and Biomedical Analysis) (2002)), each of which is incorporated by reference. Alternatively, kits for obtaining nucleic acid samples that are commercially available may also be used, such as the Rapid DNA Dephos & Ligation Kit by Roche Diagnostics Corporation, Indianapolis, Ind.; the Buccal DNA Sample Collection Kit by The Bode Technology Group, Inc., Lorton, Va.; and PSP SalivaGene DNA kits by Biocompare, San Francisco, Calif.

“Sequencing”, “sequence determination” and the like refer to any determination of information relating to the nucleotide base sequence of a nucleic acid of interest. Such information may include the identification or determination of partial as well as full sequence information of the nucleic acid. In one aspect, the term includes the determination of the identity and ordering of a plurality of contiguous nucleotides in a nucleic acid. Any known sequencing method may be used. For example, sequencing may refer to conventional sequencing, such as the Sanger method or “dideoxy” chain-termination method. Sequencing may also refer to “High throughput digital sequencing” or “next generation sequencing,” which are sequence determination methods that determine many (typically thousands to billions) of nucleic acid sequences in an intrinsically parallel manner, i.e. where DNA templates are prepared for sequencing not one at a time, but in a bulk process, and where many sequences are read out preferably in parallel, or alternatively using an ultra-high throughput serial process that itself may be parallelized. Such methods may include but are not limited to pyrosequencing (for example, as commercialized by 454 Life Sciences, Inc., Branford, Conn.); sequencing by ligation (for example, as commercialized in the SOLiD™ technology, Life Technology, Inc., Carlsbad, Calif.); sequencing by synthesis using modified nucleotides (such as commercialized in TruSeq™ and HiSeg™ technology by Illumina, Inc., San Diego, Calif., HeliScope™ by Helicos Biosciences Corporation, Cambridge, Mass., and PacBio RS by Pacific Biosciences of California, Inc., Menlo Park, Calif.), sequencing by ion detection technologies (Ion Torrent, Inc., South San Francisco, Calif.); sequencing of DNA nanoballs (Complete Genomics, Inc., Mountain View, Calif.); nanopore-based sequencing technologies (for example, as developed by Oxford Nanopore Technologies, LTD, Oxford, UK), and like highly-parallelized sequencing methods. Exemplary methods for sequence identification or determination include, but are not limited to, hybridization-based methods, such as disclosed in e.g., Drmanac, U.S. Pat. Nos. 6,864,052; 6,309,824; and 6,401,267; and Drmanac et al, U.S. patent publication 2005/0191656; sequencing-by-synthesis methods, e.g., U.S. Pat. Nos. 6,210,891; 6,828,100; 6,969,488; 6,897,023; 6,833,246; 6,911,345; 6,787,308; 7,297,518; 7,462,449 and 7,501,245; US Publication Application Nos. 20110059436; 20040106110; 20030064398; and 20030022207; Ronaghi, et al, Science, 281: 363-365 (1998); and Li, et al, Proc. Natl. Acad. Sci., 100: 414-419 (2003); ligation-based methods, e.g., U.S. Pat. Nos. 5,912,148 and 6,130,073; and U.S. Pat. Appln Nos. 20100105052, 20070207482 and 20090018024; nanopore sequencing e.g., U.S. Pat. Appln Nos. 20070036511; 20080032301; 20080128627; 20090082212; and Soni and Meller, Clin Chem 53: 1996-2001 (2007)), as well as other methods, e.g., U.S. Pat. Appln Nos. 20110033854; 20090264299; 20090155781; and 20090005252; also, see, McKernan, et al., Genome Res., 19:1527-41 (2009) and Bentley, et al., Nature 456:53-59 (2008), all of which are incorporated herein in their entirety for all purposes.

Genetic differences between individuals in organisms of all species include single nucleotide polymorphisms (SNPs), insertions, deletions, translocations and aneuploidies of whole and partial chromosomes. As would be readily apparent to one of ordinary skill in the art, the sequencing methods above can be used to detect SNPs and other structural variants to determine genetic sequences of interest that are unique to the specific source organism.

Rather than sequencing, genotyping may also be used to determine differences in the genetic make-up (genotype) of an individual by examining the individual's DNA sequence using biological assays and comparing it to another individual's sequence or a reference sequence. Examples of current methods of genotyping include restriction fragment length polymorphism identification (RFLPI) of genomic DNA, random amplified polymorphic detection (RAPD) of genomic DNA, amplified fragment length polymorphism detection (AFLPD), polymerase chain reaction (PCR), DNA sequencing, allele specific oligonucleotide (ASO) probes, and hybridization to DNA microarrays or beads.

Once the genetic data 24 is obtained, the genetic data 24 may be transmitted to the social genetics network 10 and received by the server 20. In one embodiment, the bioinformatics engine 36 may create a genetic profile for the user from the genetic data 24 and store the genetic profile in the genetic data database 28.

After the non-genetic data 26 and the genetic data 24 have been collected and stored, the bioinformatics engine 36 may analyze the genetic data 24 and the non-genetic data 26 to automatically i) assign traits to the user based at least in part on phenotypic and/or genotypic relationships found in the genetic data and the non-genetic data, and ii) determine trait connections between the user and other users in the network based on a similarity of the traits that are common to the user and the other users (block 204).

In addition, the bioinformatics engine 36 may analyze the genetic data 24 and the non-genetic data 26 to automatically iii) determine new correlations between genetic data 24 and non-genetic data 26 that may be used to create new traits and assign those to user. This may include continually analyzing the genetic data 24 and the non-genetic data 26 of all the users to determine new correlations between the users or groups of users to suggest new potential connections to those users.

As used herein a trait 38 is a distinct variant of a phenotypic character of an organism, e.g., a human, that may be inherited, environmentally determined, or a combination thereof, and may be genetic or non-genetic. Traits 38 can include both physical and behavioral characteristics, and can be shared among individuals. According to one embodiment, the social genetics network website 16 may refer to a trait 38 as a “thread”. As used herein, the terms “traits” and “threads” may be used interchangeably. Examples of traits/threads 38 may include hair color, optimism, and ancestry, for instance. The bioinformatics engine 36 generates a social genetics profile for the user based on the traits assigned to the user and the trait connections to the other users (block 206).

In one embodiment, the genetic profile generation component 50 of the bioinformatics engine 36 automatically generates the social genetics profile for the user 12, which includes an initial set of suggested connections to other users (“friends”) determined to have trait connections/commonalities with the user 12. The initial set of suggested connections may include other users identified as potential familial relatives. The genetic profile generation component 50 may also use non-genetic data 26 to determine the initial set of suggested connections, such as existing friends and followers/followees of the user as defined in existing social network(s) 56. According to one aspect of the exemplary embodiments, the a social genetics profile for the user can change over time with both input from new genetics information, such as imputation, new correlations found between the genetic data 24 and behavior in the social genetic network and existing networks, and user administration of her own genetic profile.

The bioinformatics engine 36 presents the social genetics profile to the user for display on the electronic device 14, wherein the social genetics profile comprises at least a portion of the non-genetic data, at least a portion of the traits assigned to the user, and at least a portion of the trait connections of the user to the other users (block 208).

User Interface Design

Social Genetics Profile Page

FIG. 3 is a block diagram illustrating example user interface (UI) pages that may be generated and presented to the user on electronic device 14 once connected to the social genetics network website 16. In this example, five pages are shown, a social genetics profile page 300, a compare users page 302, a view connections page 304, a thread details page 306, and a view other profile page 308.

In one embodiment, once the user 12 logs into the social genetics network website 16, the user 12 may be referred to as the “active user” and the social genetics profile page 300 may be displayed as the home screen for the active user. According to one embodiment, the social genetics profile page 300 displays a graphical representation of the active user through their genetic and non-genetic traits. The compare users page 302 may be displayed when active user selects or clicks on or selects another user in the network, and may show basic non-genetic profile data (e.g., name, picture, location) for both the active user and the selected other user as well as the traits or threads the two users have in common. The view connections page 304 is displayed when the active user selects to view all users to which the user is connected and may display a list of all users who are connected to the active user based on common traits or threads.

The thread details page 306 may be displayed when active user selects or clicks on a displayed thread. The thread details page 306 displays a description about the thread and shows all users who share that thread, and may show comments related to that thread. The view other profile page 308 may be displayed when active user selects to view a social genetics profile of another user. The view other profile page 308 is similar to the social genetics profile page 300 of the active user, but displays the genetic and non-genetic profile data of the other user and may be view only.

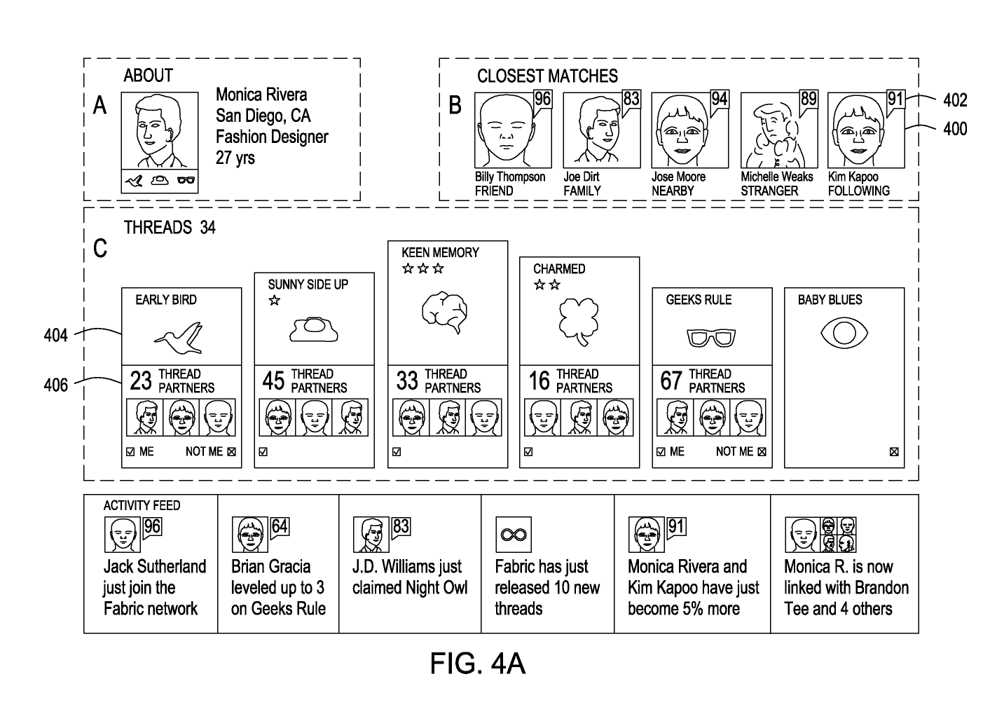

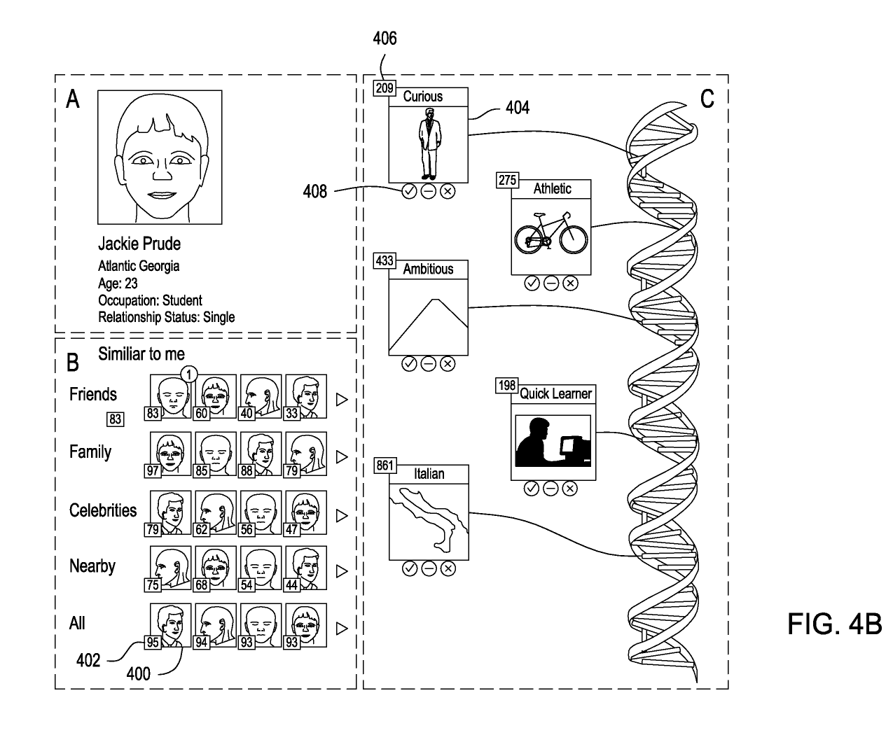

FIGS. 4A and 4B are diagrams illustrating example embodiments for the social genetics profile page 300A and 300B. The social genetics profile pages 300A and 300B (collectively referred to as the social genetics profile page 300) may comprise the home screen for the active user and shows the user's non-genetic profile information and a summary of their traits/threads.

The social genetics profile page 300 may include a plurality of sections that display different categories of information. In one embodiment, the social genetic profile page 300 may include three sections, for example, Section A, Section B, and Section C. Section A of the social genetics profile page 300 may display the non-genetic data profile information of the active user as any combination of name, profile picture, location, age, occupation, and relationship status, for example.

Section B of the social genetics profile page 300 may display other users in the network having similar trait connections with the active user. The other users displayed in Section B may be referred to as “similar users” 400. In one embodiment, Section B may be provided with a descriptive label such as “Closest Matches” or “Similar to Me”.

In one embodiment, the similarity component 48 may determine an initial set of suggested connections to similar users by computing a similarity score 402 between active user and the other users in the social genetics network 10. In one embodiment, the similarity score 402 is a number representing relative similarity between genetic and non-genetic data 24 and 26 of any pair of users, or between the active user and a group of other users. The bioinformatics engine 36 may also determine similar users by identifying family members based on family relatedness, identifying friends from an existing social network 56, identifying celebrities having similar traits, and/or identifying geographically nearby users.

In one embodiment, the N most similar users 400 may be displayed in Section B in descending order by the similarity score 402. For each of the similar users 400 displayed in Section B, the bioinformatics engine 36 may display the similar users profile picture, the similarity score between the active user and the similar user 400. Other information may be displayed for each of the similar users 400, such as name and the type or category of similar user, such as Friend, Family, Nearby, Stranger, Following, or Follower, for example. Clicking or selecting a similar user in Section B may link to the compare users page 302. Section C of the genetics profile page 300 may display a scrollable list of the traits or threads 404 assigned to the active user. Each thread 404 may be displayed with the name of the thread, an image or graphic representing the thread 404, and optionally a thread count 406 representing the number of users in the social genetics network that share that thread 404.

As shown in FIG. 4B, in one embodiment, each of threads may be displayed with a true/neutral/false rating indicator 408, which the active user may select to confirm, leave alone, or deny the initial assignment of the thread 404, or to select new threads that were not initially assigned. Any of the threads 404 initially displayed in Section C may have the true button selected by default. The FIG. 4B example also shows an embodiment where the threads 404 may be shown with lines pointing to example locations on a graphic representation of DNA that might be responsible for the thread 404. Clicking on a thread 404 in Section B may link to the thread details page 306.

In other embodiments, the bioinformatics engine 36 may include a game application component in which the user may “level up” traits by completing activities associated with each of the trait, resulting in a change to the users social genetics profile. For example, threads may have a rating system, for example rating points from 1-3, where a 3 indicates that the user has completed tasks assigned to that thread in order to demonstrate that they exemplify the assigned traits. For example, a thread entitled “Early Bird” may include a task requiring the user to login on the site before 6 AM three days in row in order to level up in that thread.

Compare Users Page

Once the active user clicks on the profile information of another user, the other user becomes the compared user and the compare user page 302 is displayed.

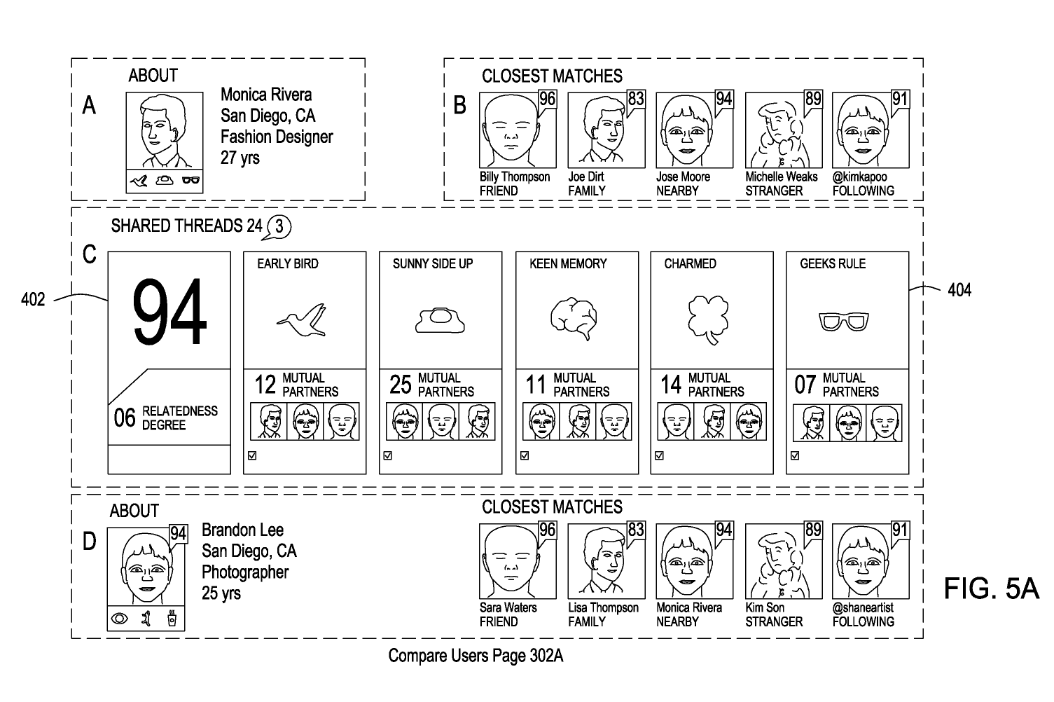

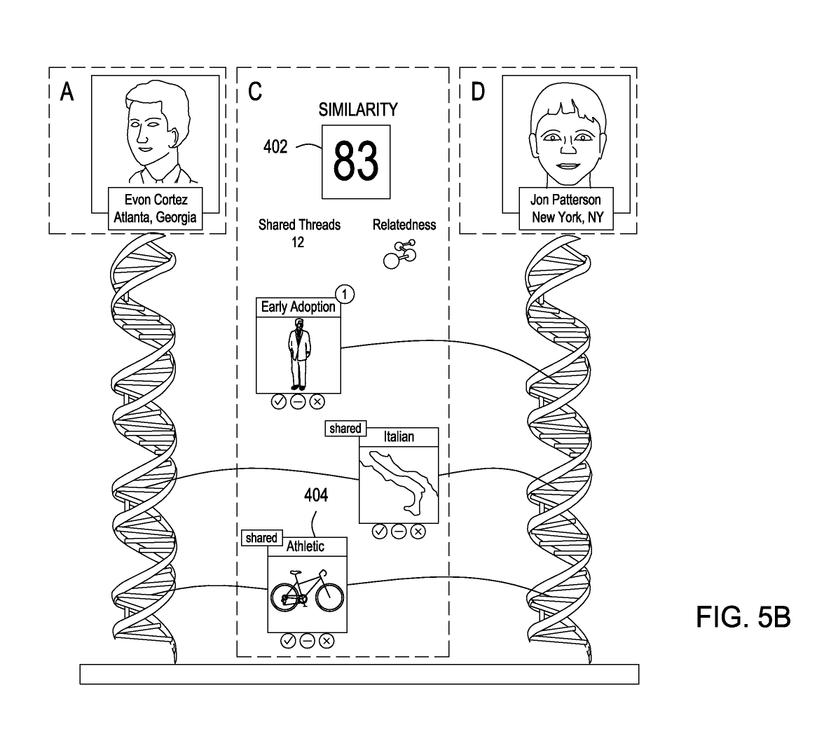

FIGS. 5A and 5B are diagrams illustrating example embodiments for the compare users page 302A and 302B. The compare users page 302A and 302B (collectively referred to as compare user page 302) displays the similarity between the active user and the compared user. The compare users page 302 may have a plurality of sections. In this example, the compare users page 302 includes four sections. In both embodiments, Section A of the compare users page 302 may display the non-genetic data profile information of the active user, while Section D displays the non-genetic data profile information of the compared user. Section C displays the threads 404 that the active user and the compared user have in common. Section C may also display the similarity score 402 calculated between the active user and the compared.

Besides graphical and layout differences, the embodiment of FIG. 5A differs from that shown in FIG. 5B in that the embodiment of FIG. 5A may further display the active user's connections to similar users in Section B, as well as the compared user's connections to similar users in Section D.

In FIG. 5B, threads that are shared between the active user and the compared user may be displayed with visual indicators showing the share thread and locations on graphic representations of the active user's and the compared user's DNA. In this embodiment, one thread that is not shared between the two users is shown and may be indicated as a potential thread that the active user and the compared user may vote on, either positively or negatively. If both users agree that this thread represents them, the system will increase the thread count of both users as well as increase the shared thread count between the two users. Threads rated as false may be removed from the compare user page 302.

One goal of displaying shared threads is that it may become the basis for the two compared users to start a conversation about the threads and perhaps decide to meet or attend an event together. In one embodiment, the compare users page 302 may also display a shared conversation that can occur between the two compared users about their shared threads.

In another embodiment, the bioinformatics engine 36 may distinguish between genetic relatedness versus expected relatedness. For instance, the bioinformatics engine 36 may initially calculate an expectation of relatedness between siblings and then determine genetically if the user is more or less similar to the sibling according to the expectation. Similarly, the bioinformatics engine 36 may create an expectation based upon race or heritage and then determine genetically if the user is more or less similar to that expectation. One or both of the genetic relatedness versus expected relatedness may be displayed to the user on one of the UI pages.

In both embodiments shown in FIGS. 5A and 5B, clicking on the compared user's profile picture may link to the view other profile page 308, and clicking on one of the displayed threads may link to the thread details page 306.

Thread Details Page

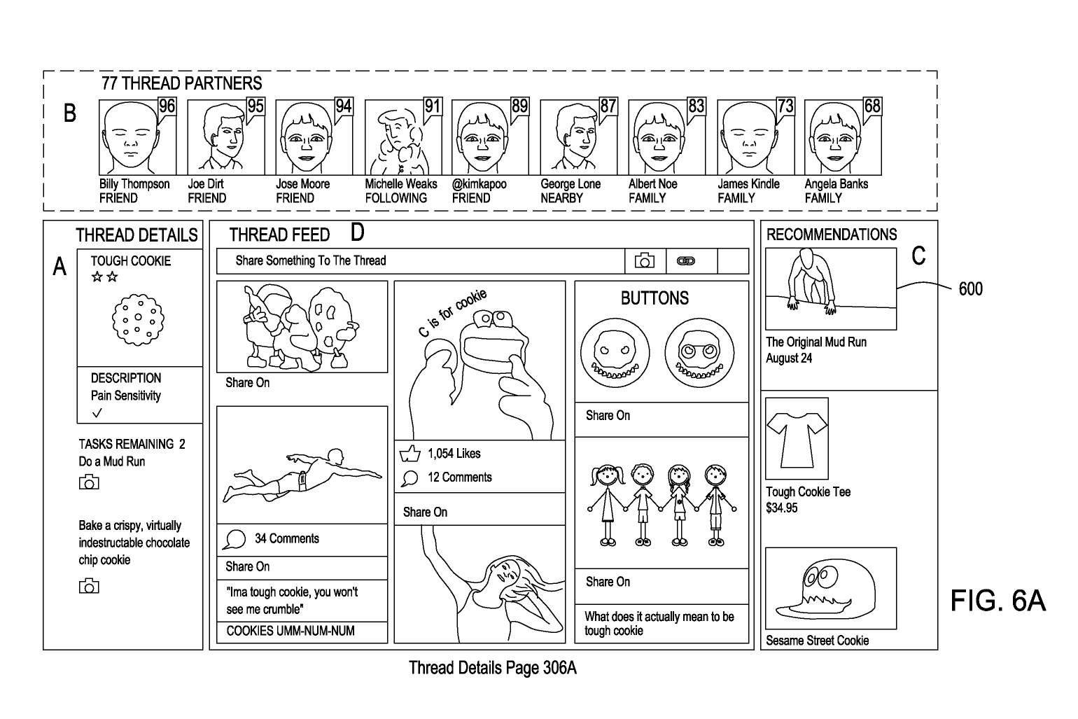

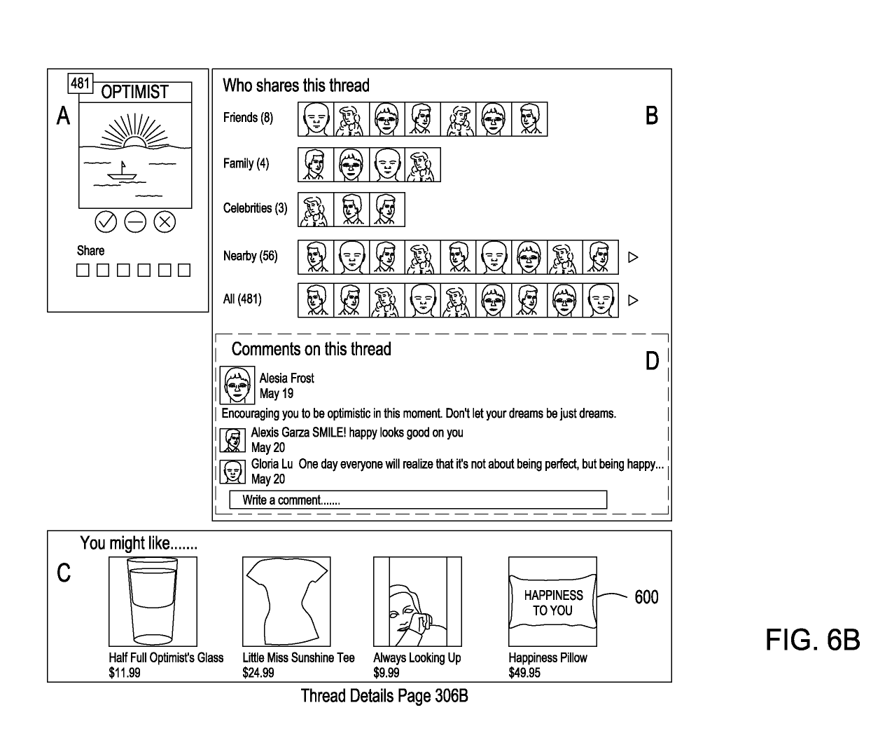

FIGS. 6A and 6B are diagrams illustrating example embodiments of the thread details page 306A and 306B. The thread details page 306A and 306B (referred to collectively as the thread details page 306) may include a plurality of sections. Section A of the thread details page 306 shows details of the thread, including a thread name, a picture representing the thread, and a text description of the thread. Section B shows the users in the network who share this thread. FIG. 6B shows that section B may display the users who share the thread in user categories such as friends, family, celebrity's, nearby, and all. The number of users sharing a thread may be displayed in either Section A or in Section B. In one embodiment, Section D may incorporate a multi-media display area capable of displaying user added content in the form of text (e.g., comments/conversation), embedded hyperlinks, pictures, video and other modes of media that users contribute to the thread. Each user's name and profile picture may be displayed next to the corresponding media they have contributed.

According to a further aspect of the exemplary embodiment, Section C displays recommended cross-sell advertisements 600 related to the displayed thread. Each of the cross-sell advertisements 600 may include a product image and description.

View Connections Page

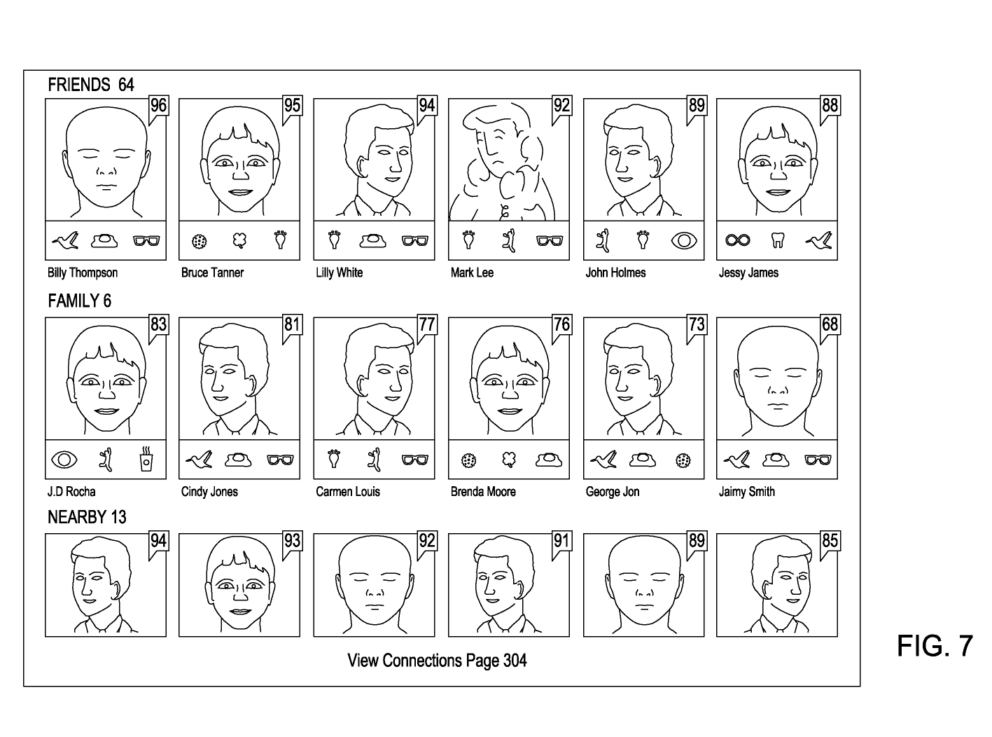

FIG. 7 is a diagram illustrating an example embodiment of the view connections page 304. The view connections page 304 may display a list of all users who are connected to the active user based on common traits or threads. In this embodiment, the active user's connections are shown displayed in a grid format, where each connection includes the name of the user, a profile picture of the user, and icons representing shared threads. The view connections page 304 may be navigated to from a menu or a navigation bar displayed at the top of the pages.

View Other Profile Page

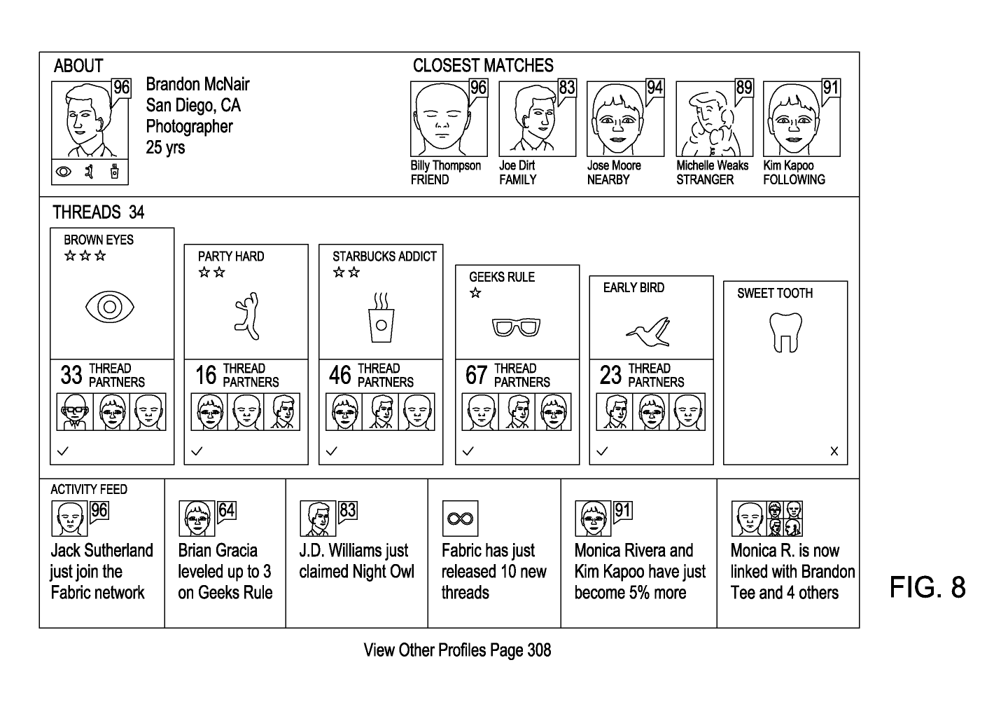

FIG. 8 is a diagram illustrating an example embodiment of the view other profile page 308. The view other profile page 308 is similar to the social genetics profile page 300 of the active user, but displays the genetic and non-genetic profile data of the a selected user and may be view only. When clicking on other user profile pictures, or when viewing other users profile pages, the active user may have the opportunity to either i) post media content either onto the other users page, or to any of the other existing social networking sites that have been linked to the user profile pages (e.g., Facebook, Twitter), or ii) connect directly to the other user in a live media application, such as voice over IP, videoconferencing, or text messaging.

Assignment of Traits

In one embodiment, the discovery component 44 of the bioinformatics engine 36 assigns traits to the user based on phenotypic and/or genotypic relationships found in the genetic data 24 and non-genetic data 26. The discovery component 44 may perform an analysis of the user's whole genome and/or perform an analysis of individual genes, sequences, or SNPs, found in the user's genetic data 24.

Automatically Assigned Traits

Examples types of information that the discovery component 44 can determine about a user based on the genetic data 24 and non-genetic data 26 may include:

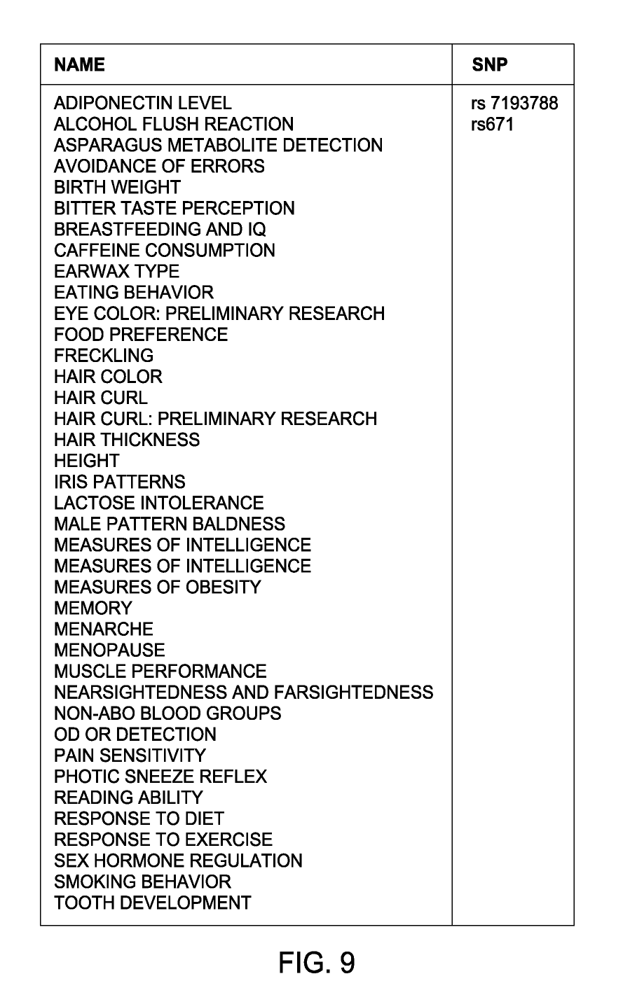

1. Phenotypic traits such as appearance (e.g., eye color), behavior (e.g., predilection for smoking), and preferences (e.g., enjoyment of bitter foods) can be determined by analyzing the user's SNPs, sequence, genes, or loci for associations with previously discovered phenotypic trait. The associations may have been discovered within the network or may be known from the scientific literature. FIG. 9 is a table illustrating examples phenotype SNPs traits.

2. Ancestry such as the geographic and regions from which a user's ancestors may have lived along with the corresponding time in history when they lived in this place or region.

3. Family relatedness or lineage such as kinship relations (e.g., elucidation of a family tree), including the family relationships to other users of the network.

4. Unique genetic identifiers such as a set of genetic elements that uniquely described an individual.

5. Correlations of a user's social and genetic attributes with the social and genetic attributes of other users. These other users could be family, romantic interests, friends, colleagues, people who have shared interests or preferences, shared ancestry, and/or celebrities.

6. Correlations of a user's social and genetic attributes with attributes of products, services, and potential preferences for such products and services.

7. Combinations and permutations of the above correlations. For example: a correlation of a user's social and genetic attributes with the attributes of another user who has similar genetic and social attributes, or who has similar product and service preferences.

Examples of the types of calculations and estimations that the discovery component 44 may perform include ancestry parameterization and hair and eye color parameterization, for instance. Ancestry parameterization may be performed to show the user 12 an estimate of the user's ancestry, show more than just the user's primary ancestry, and to allow the user to connect over their shared ancestry as a shared thread.

In one embodiment, the ancestry parameterization may be performed as follows. First, a plurality of ethnicity threads may be created. In one embodiment, four ethnicity threads may be created, for example, such as European, Asian, African, and Latino. Each user may be assigned a subset of the plurality of ethnicity threads. In one embodiment, each user may then be assigned a maximum number of the ancestry threads. In the embodiment where four ancestry threads are created, each user may be assigned a maximum of two ancestry threads, for example. In one embodiment each user may be determined to belong to an ethnicity thread or not as a binary decision. In another embodiment, each user may be determined to belong to the ethnicity threads as a percentage of ethnicity. In one embodiment, the user may have to have a minimum of 20% of their ancestry from one of those four ethnicities in order to be assigned the thread.

The hair and eye color parameterization may be performed to show the user 12 the system's best guess on the user's hair color and eye color, structuring the ancestry parameters so they are more likely to be right. In one embodiment, the hair and eye color parameterization may be performed as follows. First four hair color threads may be created: blonde, brunette, red and black; and four eye color threads may be created green, blue, brown and dark. The user is then assigned one hair color and one eye color.

Although many traits may be automatically assigned to the user 12, according to another aspect of the exemplary embodiment, the traits 38 assigned to the user may also include traits that are self-identified by the user 12. For example, the discovery component 44 of the bioinformatics engine 36 shown in FIG. 1 may display to the user a set of traits for user selection to allow the user 12 to self-identify traits about the user, or display a control that allows the user to select or vote that a trait be applied to the user. The discovery component 44 may mine the genetic and non-genetic data 26 and 26 to discover new associations between the user's traits 38, ancestry 42, family relatedness 40, and similarity to other users, and to confirm or reject the user's self-identified traits. For example, the discovery component 44 may periodically offer the user 12 new traits that the system has learned are associated in some combinations between the user's genetic and non-genetic data 24 and 26 as the network grows.

In one embodiment, the bioinformatics engine 36 may include manually created sub-threads, which are threads that are subordinate to a primary thread and include properties additional to those of the parent thread. Sub-threads may be created and self-assigned by the user for a subset of the users that shared the new sub-thread. For example, the user may create a sub-thread of “Blonde Hair Dyed Blue” under the parent thread of Blonde Hair.

In a further embodiment, the bioinformatics engine 36 may include unique celebrity traits that can be assigned to celebrities and to the users who are followers of the celebrities in the network 10. In one embodiment, the unique celebrity traits may be referred to as “golden threads”. For example, the celebrity Lady Gaga whose fans are affectionately called “little monsters” may be assigned a golden thread entitled “Mama Monster”, for instance, and any of her followers in the network 10 would be assigned a “Little Monster” thread.

Determination of Connections to Other Users Based on Trait Similarity

In one embodiment, trait connections between the user and other users may be determined by the similarity component 48 of the bioinformatics engine 36. According to a further aspect of the exemplary embodiment, the similarity component 48 may determine both the similarity of the traits common to the user and other individual users (pair-wise), and the similarity of the traits common to the user and groups of other users.

The similarity component 48 may determine connections between the user 12 and other individual users based on genetic similarity of two users by performing a genome wide similarity comparison that compares all available genetic data (e.g., loci, sequences, genotype, SNP's). The similarity component 48 may also determine the genetic similarity of two users by comparing select individual traits/genes/sequences/SNP's/genotype found in the genetic data of the two users.

According to the exemplary embodiment, the similarity component 48 may also be configured to determine the similarities between the user 12 and groups of other users by first creating a genetic composite for the group using an algorithm that determines the most likely, average, or median genetic data for the group. A genome wide similarity comparison may then be performed that determines genetic similarity of the user 12 to a group of users or vice versa by comparing all available genetic data (e.g., loci, sequences, genotype, SNP's). In another embodiment, the similarity component 48 may determine the genetic similarity of the user 12 to the group of users by comparing select individual traits/genes/sequences/SNP's/genotype from the genetic data.

In one embodiment, the similarity component 48 may determine unknown genetic information using imputation as described below to improve any of the similarity features described above.

Similarity Score

As described above, the similarity component 48 may determine connections to other users based on similarity of the traits further by calculating a similarity score (element 402 in FIGS. 4A-4B and 5A-5B).

In one embodiment, the similarity component 48 may calculate the similarity score in a range of numbers, such as for example, from 1 to 10 or from 1 to 99 and the like. In one embodiment, the lower numbers in the range indicates not at all similar, while higher numbers indicate extremely similar, or vice versa. The similarity score may be calculated for each and every pair of users in the social genetics network 10. In one embodiment, the similarity score may be calculated as described below.

The similarity score may be a linear weighted equation of factors between User A and User B, which may include genetic-based threads, non-genetic-based threads, ancestry, and relatedness. In one embodiment, initial weights assigned to the factors may be set as: Genetic threads (30%), non-genetic threads (30%), ancestry (20%), and relatedness (20%). In one embodiment, at least a portion of the factors may have user-configurable weights or percentages. For example, the user may wish to reduce the default weight associated with ancestry from 20% to 5%, and apportion, or have the system apportion, the remaining 15% to one or more of the other factors, for instance.

Each of these factors may have a minimum score of 0 and a maximum score of 1. The linear weighted equation may be expressed as:

$${Threads}_{genetic} * 30 + {Threads}_{non \text{-} genetic} * 30 + AncestryDistanceFactor * 20 + RelatednessFactor * 20$$

$$where , {Threads}_{genetic} = \frac{{SumSharedThreads}_{genetic}}{{TotalThreads}_{genetic}}$$

$${Threads}_{non \text{-} genetic} = \frac{{SumSharedThreads}_{non \text{-} genetic}}{{TotalThreads}_{non \text{-} genetic}} .$$

The ancestry distance factor AncestryDistanceFactor may be calculated as follows. The ancestry distance factor may be a function of the Euclidean distance in the n-dimensional vector space of ancestry between User A and User B. There are four dimensions in this space, as described above: European, Asian, African, and Latino. In each of these four dimensions, users will have a score ranging from 0-1. In general terms:

$$AncestryDistanceFactor = \frac{\sqrt{2} - {AncestryDistance}_{A / B}}{MaximumAncestryDistance}$$

$${AncestryDistance}_{A / B} = \sqrt{\begin{matrix}{( {Euro}_{A} - {Euro}_{B} )}^{2} + {( {Asian}_{A} - {Asian}_{B} )}^{2} + \\ {( {Afr}_{A} - {Afr}_{B} )}^{2} + {( {Lat}_{A} - {Lat}_{B} )}^{2}\end{matrix}}$$

$$MaximumAncestryDistance = \sqrt{\begin{matrix}{( 1 - 0 )}^{2} + {( 0 - 1 )}^{2} + \\ {( 0 - 0 )}^{2} + {( 0 - 0 )}^{2}\end{matrix}} = \sqrt{2}$$

The ancestry distance factor AncestryDistanceFactor may be calculated as follows:

$$RelatednessFactor = \frac{( 7 - {RelatednessScore}_{A / B} )}{6}$$

(see section below for RelatednessScore_{A/B})

Relatedness Score

The Relatedness score is an estimation representing a degree of relation between two users. If 2 users are found to be very closely related, the similarity component 48 attempts to make the relatedness score very accurate. However if two users are found to be distantly related, accuracy is less of a concern with the relatedness score the discovery component 44 may rely on existing meme of 6° of separation.

In one embodiment, the similarity component 48 may calculate the relatedness score in a range of numbers, such as for example, from 1 to 1-6 and the like. In one embodiment, the lower numbers in the range indicates a very close kin, while higher numbers, such as 6 indicate very distant. Beyond a score of 3, there may be noise and not much ability to differentiate. To compensate for this lack of precision, the similarity component 48 may use an ancestry vector between User A and User B. The relatedness score may be calculated for each and every pair of users in the social genetics network 10. Thresholds may be adjusted until scores of 4, 5 and 6 are relatively evenly represented. In one embodiment, initial values thresholds may be set as:

Relatedness score of 4: AncestryDistance_{A/B}≦0.4

Relatedness score of 5: 0.4<AncestryDistance_{A/B}<0.8

Relatedness score of 6: AncestryDistance_{A/B}≧0.8

Imputation

In one embodiment, the bioinformatics engine 36 determines traits 38, family relatedness 40, and ancestry 42 of the users based on known information in the genetic data 24 and the non-genetic data 26. According to one aspect of the present embodiment, however, where parts the genetic data 24 and the non-genetic data 26 are low quality or missing, the imputation component 46 may augment one or more of the determination of the traits 38, the family relatedness 40, and the ancestry 42 of the users by inferring the low quality or missing genetic data 24 and the non-genetic data 26.

For example, the imputation component 46 may determine unknown parts of traits/gene/sequences/SNP's/genotype using known genetic information, such as access to genetic information of other users who are familial relatives. In addition, with access to genetic information of other users who are familial relatives, imputation component 46 may impute the user's genome.

More specifically, the genetic data 24, such as genomic DNA sequence data and genotype data, for the user 12 is incomplete and portions of the genotype or genome are not known, it can be improved by imputing the missing portions. Imputation allows the estimation of unknown portions of a user's genome by comparing and correlating the known portions of the user's genome with databases that include both the known and unknown portions for other people. Using correlation and imputation algorithms, one can estimate the unknown portions of the user's genome. See for example, Browning, Brian L, and Sharon R Browning. “A Unified Approach to Genotype Imputation and Haplotype-Phase Inference for Large Data Sets of Trios and Unrelated Individuals.” American journal of human genetics 84, no. 2 (2009): doi:10.1016/j.ajhg.2009.01.005; Li, Yun, Cristen J Willer, Jun Ding, Paul Scheet, and Gonçalo R Abecasis. “Mach: Using Sequence and Genotype Data to Estimate Haplotypes and Unobserved Genotypes.” Genetic epidemiology 34, no. 8 (2010): doi:10.1002/gepi.20533; and Marchini, Jonathan, Bryan Howie, Simon Myers, Gil McVean, and Peter Donnelly. “A New Multipoint Method for Genome-Wide Association Studies by Imputation of Genotypes.” Nature genetics 39, no. 7 (2007): doi:10.1038/ng2088, which are Incorporated herein by reference.

This imputation may be done using known genotype and sequence data from a database such as the HapMap project or 1000 genomes. It may also come from a custom built database that includes sequence or genotype data from the other members of network. If genomic or genotype data of known relatives can be used, the imputation accuracy improves. These relatives may or not be part of the network.

In the extreme case, it is possible to create a virtual genome fully imputed for a user without having any actual sequence data or genotype data for that user, so long as genetic data on known relatives is available. The more data and the closer the relatives, the more accurate the virtual genome becomes.

Furthermore, additional inferences can be made by analyzing the statistical relationships between data sets. These analyses will lead to stronger predictions of the inferences described above and will undoubtedly also lead to new inferences that were previously not described.

The following literature gives examples of the type of information and corresponding analyses that can be used to make such inferences, all of which are incorporated herein by reference:

Ancestry Estimation:

Alexander, David H, John Novembre, and Kenneth Lange. “Fast Model-Based Estimation of Ancestry in Unrelated Individuals.” Genome research 19, no. 9 (2009): doi:10.1101/gr.094052.109; and

Pritchard, J K, M Stephens, and P Donnelly. “Inference of Population Structure Using Multilocus Genotype Data.” Genetics 155, no. 2 (2000): 945-59.

Relationship Inference:

Kirkpatrick, Bonnie, Shuai Li, Richard Karp, and Eran Halperin. “Pedigree Reconstruction Using Identity by Descent.” In Research in Computational Molecular Biology. Edited by Vineet Bafnand S Sahinalp. Lecture Notes in Computer Science. Springer Berlin/Heidelberg, 2011.dx.doi.org/10.1007/978-3-642-20036-6_{—}15;

Manichaikul, Ani, Josyf C Mychaleckyj, Stephen S Rich, Kathy Daly, Michele Sale, and Wei-Min Chen. “Robust Relationship Inference in Genome-Wide Association Studies.” Bioinformatics (Oxford, England) 26, no. 22 (2010): doi:10.1093/bioinformatics/btq559;

Pemberton, Trevor J, Chaolong Wang, Jun Z Li, and Noah A Rosenberg. “Inference of Unexpected Genetic Relatedness Among Individuals in Hapmap Phase III.” American journal of human genetics 87, no. 4 (2010): doi:10.1016/j.ajhg.2010.08.014.

Rohlfs, Rori V, Stephanie Malia Fullerton, and Bruce S Weir. “Familial Identification: Population Structure and Relationship Distinguishability.” PLoS genetics 8, no. 2 (2012): doi:10.1371/journal.pgen.1002469.

Stankovich, Jim, Melanie Bahlo, Justin P Rubio, Christopher R Wilkinson, Russell Thomson, Annette Banks, Maree Ring, Simon J Foote, and Terence P Speed. “Identifying Nineteenth Century Genealogical Links From Genotypes.” Human genetics 117, no. 2-3 (2005): doi:10.1007/s00439-005-1279-y.

Phenotype Prediction:

Evans, David M, Peter M Visscher, and Naomi R Wray. “Harnessing the Information Contained Within Genome-Wide Association Studies to Improve Individual Prediction of Complex Disease Risk.” Human molecular genetics 18, no. 18 (2009): doi:10.1093/hmg/ddp295;

Lee, Sang Hong, Julius H J van der Werf, Ben J Hayes, Michael E Goddard, and Peter M Visscher. “Predicting Unobserved Phenotypes for Complex Traits From Whole-Genome SNP Data.” PLoS genetics 4, no. 10 (2008): doi:10.1371/journal.pgen.1000231.

Wei, Zhi, Kai Wang, Hui-Qi Qu, Haitao Zhang, Jonathan Bradfield, Cecilia Kim, Edward Frackleton, and others. “From Disease Association to Risk Assessment: An Optimistic View From Genome-Wide Association Studies on Type 1 Diabetes.” PLoS genetics 5, no. 10 (2009): doi:10.1371/journal.pgen.1000678;

Wray, Naomi R, Michael E Goddard, and Peter M Visscher. “Prediction of Individual Genetic Risk of Complex Disease.” Curr Opin Genet Dev 18, no. 3 (2008): doi:10.1016/j.gde.2008.07.006;

“Prediction of Individual Genetic Risk to Disease From Genome-Wide Association Studies.” Genome research 17, no. 10 (2007): doi:10.1101/gr.6665407;

Heritability Estimation: Lee, Sang Hong, Naomi R Wray, Michael E Goddard, and Peter M Visscher. “Estimating Missing Heritability for Disease From Genome-Wide Association Studies.” American journal of human genetics 88, no. 3 (2011): doi:10.1016/j.ajhg.2011.02.002;

Lee, S Hong, Teresa R Decandia, Stephan Ripke, Jian Yang, Patrick F Sullivan, Michael E Goddard, Matthew C Keller, Peter M Visscher, and Naomi R Wray. “Estimating the Proportion of Variation in Susceptibility to Schizophrenia Captured by Common Snps.” Nature genetics 44, no. 7 (2012): doi:10.1038/ng0712-831a; and

Yang, Jian, S Hong Lee, Michael E Goddard, and Peter M Visscher. “GCTA: A Tool for Genome-Wide Complex Trait Analysis.” American journal of human genetics 88, no. 1 (2011): doi:10.1016/j.ajhg.2010.11.011.

Furthermore, the statistical power of the network will improve as the size and quality of the network grows. See for example: Turner, Stephen, Loren L Armstrong, Yuki Bradford, Christopher S Carlson, Dana C Crawford, Andrew T Crenshaw, Mariza de Andrade, and others. “Quality Control Procedures for Genome-Wide Association Studies.” Current protocols in human genetics/editorial board, Jonathan L. Haines . . . [et al.] Chapter 1 (2011): doi:10.1002/0471142905.hg0119s68; and Weale, Michael E. “Quality Control for Genome-Wide Association Studies.” Methods in molecular biology (Clifton, N.J.) 628 (2010): doi:10.1007/978-1-60327-367-1_{—}19.

Cross-Sell Advertisements Related to Genetic Data

In one embodiment, the social genetics network 10 offers services to the user at no cost, and recoups business cost and/or generates profit by cross-selling products and services that are determined to be related to, or complementary of, the user's genetic data 24 and product preferences. Thus, while offering entertainment services to the network of users, the social genetics network 10 also may offer business services to advertisers 60, product manufacturers and services providers.

Referring again to FIG. 1, according to a further aspect of the exemplary embodiment, the bioinformatics engine 36 may also include an advertising analysis component 54 that determines product and service advertisements related to at least one of the genetic data 24 and correlations between the genetic data 24 and the non-genetic data 26 of the user and to display one or more of the product and service advertisements based on product preferences of the user.

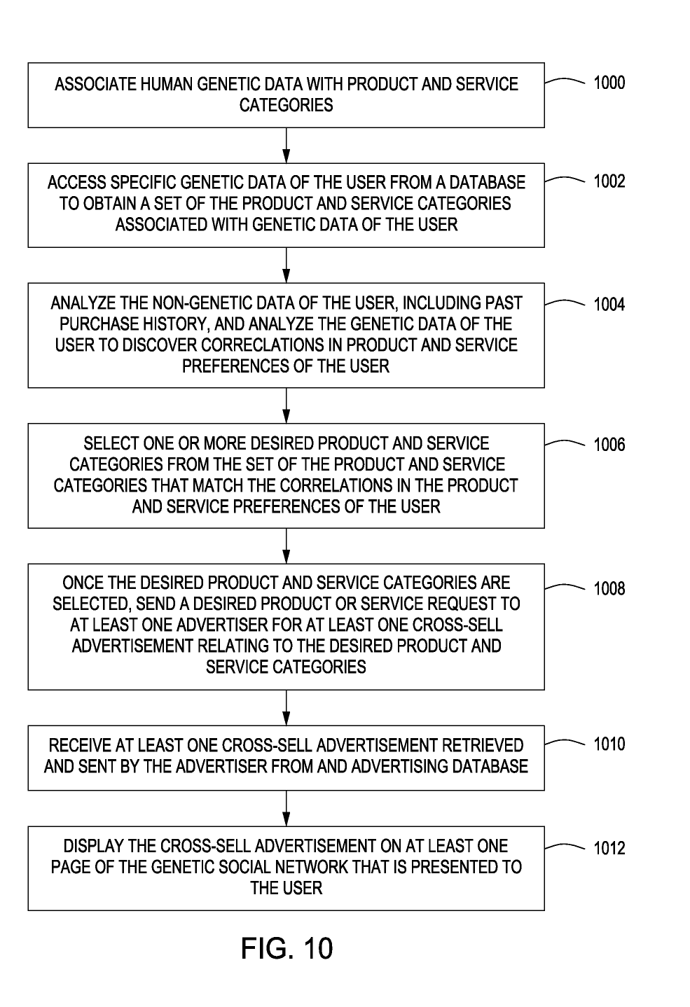

FIG. 10 is flow diagram illustrating one embodiment for the process of displaying cross-sell advertisements related to genetic data of a user. The process may begin by the advertising analysis component 54 associating human genetic data 24 with product and service categories (block 1000). In this embodiment, the genetic data 24 may comprise any combination of traits, genes, sequences, genotype, and SNP's found in the genetic data of the user, a group of users or a reference genome. The association between the genetic data and the product and service categories may be stored in the database 22.

The advertising analysis component 54 may access specific genetic data 24 of the user from the database 22 to obtain a set of the product and service categories associated the genetic data 24 of the user (block 1002). In one embodiment, the advertising analysis component 54 may access the genetic database to determine the set of traits assigned to user, and then obtain the product and service categories associated with the traits assigned to the user.

The advertising analysis component 54 may also analyze the non-genetic data 26 of the user, including past purchase history, and analyze the genetic data 24 of the user to discover correlations in product and service preferences of the user (block 1004). The advertising analysis component 54 may also analyze the genetic data 24 or a further analyzed version of the genetic data to find correlations between a user's sequence or genotype with the user's product or service preferences. In another embodiment, the advertising analysis component 54 may consider a product or service that is of interest to one user and then using the similarity score, offer similar users the same product or service.

The advertising analysis component 54 selects one or more desired product and service categories from the set of the product and service categories that match the correlations in the product and service preferences of the user (block 1006). At this point a cross-sell advertisement belonging to one of the product and service categories may be displayed to the user, as described below.

Referring to both FIGS. 1 and 10, once the desired product and service categories are determined, the advertising analysis component 54 may send a desired product or service request to at least one advertiser 60 for at least one cross-sell advertisement relating to the desired product and service categories (block 1008). The advertising analysis component 54 receives at least one cross-sell advertisement retrieved and sent by the advertiser 60 from an advertising database 62 (block 1010). In one embodiment, a plurality of the requested cross-sell advertisements may be cached or stored in the database 22. The cross-sell advertisement is then displayed on at least one page of the genetic social network that is presented to the user (block 1012).

In one embodiment, the cross-sell advertisement may be displayed adjacent to a corresponding trait to which the cross-sell advertisement is associated via the product and service categories. In FIGS. 6A and 6B, for example, Section C of the thread details page may display cross-sell advertisements 600 related to the displayed thread, where each of the cross-sell advertisement 600 may include a product image and description. The social genetics network website 16 may collect at least a portion of advertising revenue arising from display of the cross-sell advertisement.

A method and system for displaying cross-sell advertisements to a user, including but not limited to, in a social genetics network have been disclosed. The present invention has been described in accordance with the embodiments shown, and there could be variations to the embodiments, and any variations would be within the spirit and scope of the present invention. For example, the exemplary embodiment can be implemented using hardware, software, a computer readable medium containing program instructions, or a combination thereof. Software written according to the present invention is to be either stored in some form of computer-readable medium such as a memory, a hard disk, or a CD/DVD-ROM and is to be executed by a processor. Accordingly, many modifications may be made by one of ordinary skill in the art without departing from the spirit and scope of the appended claims.

We claim:

1. A method for displaying cross-sell advertisements to a user performed by software executing on at least one processor comprising or coupled to at least one server on a network, the method comprising:
associating human genetic data with product and service categories;
accessing specific genetic data of a user from a database to obtain a set of product and service categories associated with the genetic data of the user;
analyzing non-genetic data of the user, including past purchase history, and analyzing the genetic data of the user to discover correlations in product and service preferences of the user;
selecting one or more desired product and service categories from the set of the product and service categories that match the correlations in the product and service preferences of the user;
sending a product or service request to at least one advertiser for at least one cross-sell advertisement relating to the desired product and service categories; and
responsive to receiving at least one cross-sell advertisement from the advertiser, displaying the at least one cross-sell advertisement on an electronic device of the user.

2. The method of claim 1 wherein the human genetic data comprises any combination of traits, genes, sequences, genotype, and SNP's found in the genetic data of at least one of the user, a group of users and a reference genome.

3. The method of claim 2 wherein accessing specific genetic data of the user further comprises:
receiving non-genetic data and genetic data about the user and storing the non-genetic data in a database;
analyzing the genetic data and the non-genetic data to assign traits to the user based at least in part on phenotypic and/or genotypic relationships found in the genetic data and the non-genetic data, wherein each of the traits have been associated with the product and service categories; and
determining a set of traits assigned to the user to obtain the set of product and service categories associated with the traits assigned to the user.

4. The method of claim 3 further comprising:
displaying the traits assigned to the user; and
displaying the at least one cross-sell advertisement adjacent to a corresponding trait to which the cross-sell advertisement is associated via the product and service categories.

5. The method of claim 4 further comprising: displaying the at least one cross-sell advertisement as part of content provided from a social genetics network that creates social relations or networks among users based on the genetic data and the non-genetic data describing those users.

6. The method of claim 1 wherein analyzing the non-genetic data of the user further comprises: analyzing the genetic data or a further analyzed version of the genetic data to define correlations between the user sequence or genotype with the product and service preferences of the user.

7. An executable software product stored on a non-transitory computer-readable medium containing program instructions for creating a social genetics network, the program instructions for:
associating human genetic data with product and service categories;
accessing specific genetic data of a user from a database to obtain a set of product and service categories associated with the genetic data of the user;
analyzing non-genetic data of the user, including past purchase history, and analyzing the genetic data of the user to discover correlations in product and service preferences of the user;
selecting one or more desired product and service categories from the set of the product and service categories that match the correlations in the product and service preferences of the user;
sending a product or service request to at least one advertiser for at least one cross-sell advertisement relating to the desired product and service categories; and
responsive to receiving at least one cross-sell advertisement from the advertiser, displaying the at least one cross-sell advertisement on an electronic device of the user.

8. The executable software product of claim 7 wherein the human genetic data comprises any combination of traits, genes, sequences, genotype, and SNP's found in the genetic data of at least one of the user, a group of users and a reference genome.

9. The executable software product of claim 8 wherein instructions for accessing specific genetic data of the user further comprises program instructions for:
receiving non-genetic data and genetic data about the user and storing the non-genetic data in a database;
analyzing the genetic data and the non-genetic data to assign traits to the user based at least in part on phenotypic and/or genotypic relationships found in the genetic data and the non-genetic data, wherein each of the traits have been associated with the product and service categories; and
determining a set of traits assigned to the user to obtain the set of product and service categories associated with the traits assigned to the user.

10. The executable software product of claim 9 further comprising program instructions for:
displaying the traits assigned to the user; and
displaying the at least one cross-sell advertisement adjacent to a corresponding trait to which the cross-sell advertisement is associated via the product and service categories.

11. The executable software product of claim 10 further comprising program instructions for: displaying the at least one cross-sell advertisement as part of content provided from a social genetics network that creates social relations or networks among users based on the genetic data and the non-genetic data describing those users.

12. The executable software product of claim 7 wherein analyzing the non-genetic data of the user further comprises program instructions for: analyzing the genetic data or a further analyzed version of the genetic data to define correlations between the user sequence or genotype with the product and service preferences of the user.

13. A system, comprising:
a memory;
a processor coupled to the memory; and
a software component executed by the processor that is configured to:
associate human genetic data with product and service categories;
access specific genetic data of a user from a database to obtain a set of product and service categories associated with the genetic data of the user;
analyze non-genetic data of the user, including past purchase history, and analyzing the genetic data of the user to discover correlations in product and service preferences of the user;
select one or more desired product and service categories from the set of the product and service categories that match the correlations in the product and service preferences of the user;
send a product or service request to at least one advertiser for at least one cross-sell advertisement relating to the desired product and service categories; and
responsive to receiving at least one cross-sell advertisement from the advertiser, display the at least one cross-sell advertisement on an electronic device of the user.

14. The system of claim 13 wherein the human genetic data comprises any combination of traits, genes, sequences, genotype, and SNP's found in the genetic data of at least one of the user, a group of users and a reference genome.

15. The system of claim 14 wherein accessing specific genetic data of the user further comprises:
receiving non-genetic data and genetic data about the user and storing the non-genetic data in a database;
analyzing the genetic data and the non-genetic data to assign traits to the user based at least in part on phenotypic and/or genotypic relationships found in the genetic data and the non-genetic data, wherein each of the traits have been associated with the product and service categories; and
determining a set of traits assigned to the user to obtain the set of product and service categories associated with the traits assigned to the user.

16. The system of claim 15 further comprising:
displaying the traits assigned to the user; and
displaying the at least one cross-sell advertisement adjacent to a corresponding trait to which the cross-sell advertisement is associated via the product and service categories.

17. The system of claim 16 further comprising: displaying the at least one cross-sell advertisement as part of content provided from a social genetics network that creates social relations or networks among users based on the genetic data and the non-genetic data describing those users.

18. The system of claim 13 wherein analyzing the non-genetic data of the user further comprises: analyzing the genetic data or a further analyzed version of the genetic data to define correlations between the user sequence or genotype with the product and service preferences of the user.

19. A method for displaying cross-sell advertisements to a user performed by software executing on at least one processor comprising or coupled to at least one server on a network, the method comprising:
receiving non-genetic data about the user and storing the non-genetic data in a database;
receiving genetic data of a user and storing the genetic data in the database;
analyzing the genetic data and the non-genetic data to i) assign traits to the user based at least in part on phenotypic and/or genotypic relationships found in the genetic data and the non-genetic data, and ii) determine correlations between genetic data and non-genetic data;
determining product and service advertisements related to at least one of the genetic data and the correlations between genetic data and the non-genetic data; and
displaying one or more of the product and service advertisements on an electronic device based on product preferences of the user.

20. The method of claim 19 further comprising:
determining trait connections between the user and other users based on a similarity of the traits that are common to the user and the other users; and
generating a social genetics profile for the user based on the traits assigned to the user and the trait connections with the other users;
displaying the social genetics profile to the user for display on the electronic device, wherein the social genetics profile includes at least a portion of the non-genetic data, at least a portion of the traits assigned to the user, and at least a portion of the trait connections of the user to the other users.

21. The method of claim 20 wherein analyzing the genetic data and the non-genetic data to assign traits to the user further comprises:
determining from the genetic data and the non-genetic data, phenotypic traits based on at least one of sequence data and genotype data, ancestry, family relatedness, genetic identifiers, and correlations between the genetic data and the non-genetic data.

22. The method of claim 20 wherein displaying the social genetics profile to the user to include at least a portion of the trait connections of the user to the other users further comprises:
displaying N most similar users in descending order, and displaying for each of the similar users a profile picture, and a similarity score between the user and a similar user.

23. The method of claim 19 wherein analyzing the genetic data and the non-genetic data to assign traits to the user further comprises:
augmenting a determination of traits, family relatedness, and the ancestry of the user by inferring low quality or missing genetic data and the non-genetic data.

24. The method of claim 19 wherein determining connections between the user and other users further comprises:
determining both the similarity of the traits common to the user and other individual users, and the similarity of the traits common to the user and a group of other users.

25. The method of claim 19 further comprising:
displaying the at least one cross-sell advertisement as part of content provided from a social genetics network that creates social relations or networks among users based on the genetic data and the non-genetic data describing those users.
